(19) United States
(12) Patent Application Publication
(10) Pub. No.: US 2023/0004469 A1
(43) Pub. Date: Jan. 5, 2023

(54) MANAGEMENT ACTION PREDICTIONS

(71) Applicant: Hewlett-Packard Development Company, L.P., Spring, TX (US)

(72) Inventor: Christoph Graham, Spring, TX (US)

(21) Appl. No.: 17/364,559

(22) Filed: Jun. 30, 2021

(51) Int. Cl. G06F 11/30; G06N 20/00

(52) U.S. Cl. CPC G06F 11/3072; G06N 20/00; G06F 11/3051

(57) ABSTRACT

In some examples, a method includes monitoring device management actions. In some examples, the method includes predicting whether a proposed operation will trigger a device management action based on triggers and the device management actions. In some examples, the method may include generating a message in response to predicting that the proposed operation will trigger the device management action.

### BACKGROUND

The use of electronic devices has expanded. Computing devices are a kind of electronic device that include electronic circuitry for performing processing. As processing capabilities have expanded, computing devices have been utilized to perform more functions. For example, a variety of computing devices are used for work, communication, and entertainment. Computing devices may be linked to a network to facilitate communication between computing devices.

### BRIEF DESCRIPTION OF THE DRAWINGS

FIG. 1 is a flow diagram illustrating an example of a method for management action prediction;

FIG. 2 is a flow diagram illustrating an example of a method for management action prediction;

FIG. 3 is a block diagram of an example of an apparatus that may be used for management action prediction; and

FIG. 4 is a block diagram illustrating an example of a computer-readable medium for management action prediction.

### DETAILED DESCRIPTION

Automated setup is a procedure to automatically set up and/or manage a computing device or devices. For instance, automated setup may be utilized to increase efficiency in computing device setup and/or management. In some examples, automated setup may utilize instructions (e.g., scripts, policies, templates, etc.) to provision new computing devices and/or computing devices in a base state. In some examples, automated setup may be utilized to reduce setup errors as they occur. In some examples, automated setup may provide a high degree of control over computing device setup (for a management server and/or information technology (IT) administrator, for instance).

Automated setup can become unwieldy when dealing with computing devices that operate with disparate environments, infrastructure, and/or in different states. For instance, some computing devices may have deviated from a base state, may have unique setup details, and/or may have different settings due to user variation. In some cases, an automated setup action may trigger further setup actions and/or may create side effects.

Some examples of the techniques described herein may generate a message when an action (e.g., instruction, policy, template, etc.) will generate a condition (e.g., setup change, side effect, behavior, etc.) that will trigger another action. In some examples, conditions (e.g., setup changes, side effects, behaviors, etc.) may be identified and/or cataloged against a database of actions and triggers. In some examples, this information may be utilized to predict single and multi-stage actions, including the identification of cyclical actions.

An electronic device is a device that includes electronic circuitry (e.g., integrated circuitry, etc.). A computing device is an electronic device that includes a processor and/or logic circuitry. Examples of computing devices may include desktop computers, laptop computers, tablet devices, smartphones, televisions, game consoles, smart speakers, voice assistants, etc. A computing device may utilize processor(s) and/or logic circuitry to perform an operation or operations. In some examples, computing devices may execute instructions stored in memory to perform the operation(s). Instructions may be code and/or programming that specifies functionality or operation of the circuitry. In some examples, instructions may be stored in non-volatile memory (e.g., Read-Only Memory (ROM), Erasable Programmable Read-Only Memory (EPROM), Electrically Erasable Programmable Read-Only Memory (EEPROM), flash memory, etc.).

In some examples, a computing device may be linked to another electronic device or devices using a wired and/or wireless link. For example, a computing device may include a communication interface for linking to an electronic device (e.g., switch, router, server, and/or computer, etc.). Examples of wired communication interfaces may include an Ethernet interface, Universal Serial Bus (USB) interface, fiber interface, Lightning® interface, etc. In some examples, a computing device may include a wireless communication interface to send and/or receive wireless (e.g., radio frequency (RF)) signals. Examples of wireless communication interfaces may include an Institute of Electrical and Electronics Engineers (IEEE) 802.11 (Wi-Fi) interface, Bluetooth® interface cellular (e.g., 3G, Long-Term Evolution (LTE), 4G, 5G, etc.) interface, etc.

A link between electronic devices may be a direct link (e.g., without an intervening device) or an indirect link (e.g., with an intervening device or devices). For instance, a link may be established between electronic devices over a network using a modem(s), router(s), switch(es), hub(s), and/or repeater(s), etc.

Throughout the drawings, similar reference numbers may designate similar or identical elements. When an element is referred to without a reference number, this may refer to the element generally, with and/or without limitation to any particular drawing or figure. In some examples, the drawings are not to scale and/or the size of some parts may be exaggerated to more clearly illustrate the example shown. Moreover, the drawings provide examples in accordance with the description. However, the description is not limited to the examples provided in the drawings.

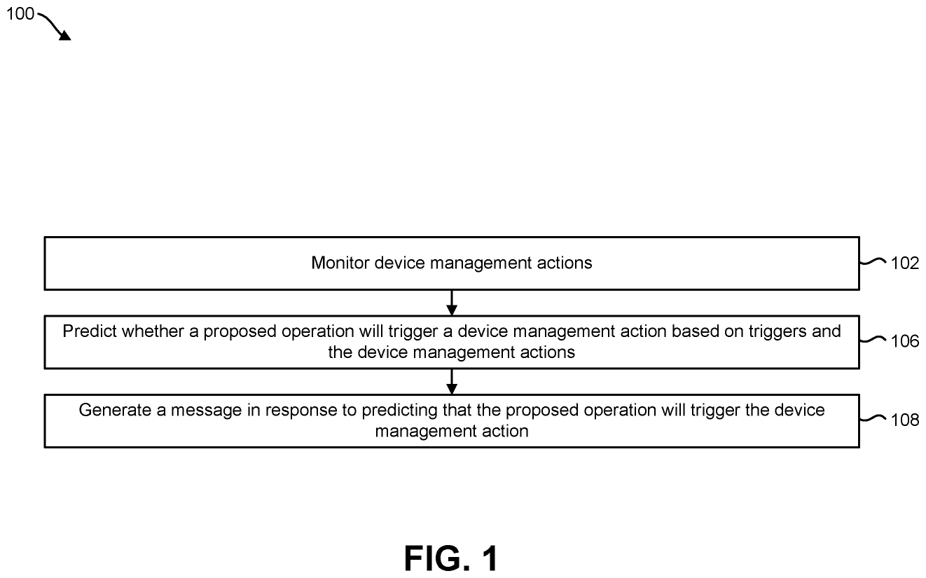

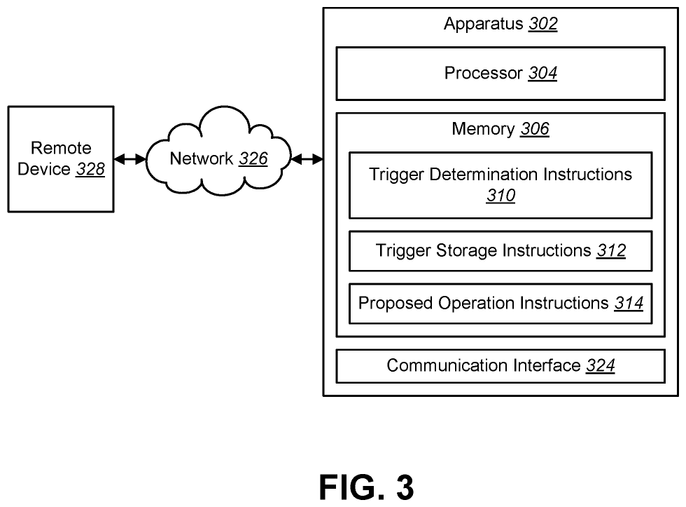

FIG. 1 is a flow diagram illustrating an example of a method 100 for management action prediction. The method 100 and/or a method 100 element or elements may be performed by an apparatus (e.g., computing device, server, etc.). For example, the method 100 may be performed by the apparatus 302 described in relation to FIG. 3.

The apparatus may monitor 102 device management actions. A device management action is the execution of an instruction or instructions (e.g., policy, template, etc.) to modify a device (e.g., remote device, client device, endpoint device, etc.). For instance, the apparatus may execute a device management action to cause a modification of an operating system (OS) (e.g., OS updates, version, etc.), installed application(s), and/or setting(s) (e.g., network setting(s), security setting(s), etc.) of a device (or devices).

In some examples, the device may be a remote device. A remote device is a device that is separate from the apparatus. In some examples, a remote device may be linked to the apparatus via a communication network or networks. Examples of a remote device may include a computing device, electronic device, smartphone, tablet device, desktop computer, laptop computer, server, game console, client device, endpoint device, end user device, etc. In some examples, a remote device may be a client device. For instance, the apparatus may be a server (e.g., cloud device, back-end device, server-side device, etc.) and/or the remote device may be a client device. In some examples, a remote device or client device may not be a back-end device, server-side device, or cloud device.

In some examples, the apparatus may communicate with an agent on a device (e.g., remote device, client device, endpoint device, end-user device, etc.) to perform the management action and/or to modify the device. An agent is an application or program that performs an operation on a device for another device or program and/or in coordination with another device or program. For instance, a device may have an agent installed. The agent may perform an operation on the device in response to the management action from the apparatus. For instance, the agent may receive a message in accordance with the management action to modify an OS, application(s), and/or setting(s) on device. For instance, the agent may install an application, remove an application, change a registry value, install a driver, change network settings, and/or perform another operation indicated by the management action.

In some examples, the apparatus may monitor 102 device management actions by detecting and/or storing when a management action occurs. For instance, the apparatus may record management actions in a data structure (e.g., database, table, etc.).

A trigger is data indicating a condition, behavior, change, and/or notification that causes a device management action to occur. In some examples, the apparatus may track and/or store triggers associated with the device management actions. In some examples, the triggers may include a condition that satisfies a logic expression. Examples of triggers may include a registry change, application installation, setting change, OS update, and/or a notification thereof. For instance, when a device (e.g., remote device, client device, etc.) is modified, the agent may send a notification to the apparatus indicating the change to the device. The apparatus may evaluate the change using a logic expression (e.g., logical Boolean expression). If the logic expression is satisfied, the apparatus may trigger a device management action. Data indicating the change that caused the device management action may be stored as a trigger.

In some examples, the method 100 may include receiving a change notification from a remote device (e.g., client device, endpoint device, etc.). For example, an agent on the remote device may detect a change. Examples of changes may include a registry change, application installation, application removal, setting change, etc. The agent on the remote device may send a change notification indicating the change to the apparatus. In some examples, the apparatus may determine that the change notification triggered a first device management action. For example, the apparatus may detect that the first management action (of the monitored device management actions) was executed in response to the change notification. In some examples, the apparatus may detect that a logic expression was satisfied by the change notification to trigger execution of the first device management action. In some examples, storing the triggers may include storing a first trigger corresponding to the first device management action in response to determining that the change notification triggered the first device management action. For instance, the apparatus may store the first trigger as data representing the change indication, a condition indicated by the change notification, and/or a behavior indicated by the change notification.

The apparatus may predict 106 whether a proposed operation will trigger a device management action based on the triggers and the device management actions. A proposed operation is an operation to modify a device (e.g., remote device, client device, client-side device, endpoint device, etc.). For example, a proposed operation may be an operation that may be potentially performed by the apparatus. In some examples, a proposed operation may be an operation that is received (e.g., input by a user, sent from another device, etc.). In some examples, a proposed operation may be a device management action that has not been executed.

In some examples, predicting 106 whether a proposed operation will trigger a device management action may include determining whether the proposed operation will cause a logic expression to be satisfied. For instance, the apparatus may evaluate a logic expression or expressions using a condition (e.g., change, behavior, etc.) that would be caused if the proposed operation were executed. If the condition satisfies the logic expression, The apparatus may determine that the proposed operation will trigger a device management action if the proposed operation would cause a condition that would satisfy a logic expression. A prediction that a proposed operation will trigger a device management action may mean that there is potential to trigger the device management action according to the prediction. For instance, a device management action may or may not actually occur after a prediction that a proposed operation will trigger the device management action. In some examples, the prediction that a proposed operation will trigger a device management action may mean that if the proposed operation is executed, that a device management action may be planned on being provided.

In some examples, predicting 106 whether a proposed operation will trigger a device management action may include determining whether the proposed operation is associated with a trigger. For instance, the apparatus may determine whether the proposed operation corresponds to a trigger that caused a device management action. For example, the apparatus may determine whether the proposed operation is a trigger and/or would result in a trigger. In some examples, the apparatus may utilize the proposed operation to attempt to look up a corresponding trigger or triggers in a data structure (in a case that the proposed operation is a trigger or includes a function that is a trigger, for instance). The apparatus may determine that the proposed operation will trigger a device management action in a case that a corresponding trigger is found.

In some examples, the apparatus (or another device) may train a machine learning model based on the device management actions and the stored triggers. Some examples of the techniques described herein may utilize machine learning. Machine learning is a technique where a machine learning model is trained to perform a task based on a set of examples (e.g., data). Examples of machine learning may include support vector machine (SVM), clustering (e.g., k-nearest neighbor), and artificial neural networks. In some examples, training a machine learning model may include determining weights corresponding to structures of the machine learning model. In some examples, artificial neural networks may be a kind of machine learning model that may be structured with nodes, layers, connections, or a combination thereof.

Examples of neural networks may include convolutional neural networks (CNNs) (e.g., CNN, deconvolutional neural network, inception module, residual neural network, etc.) and recurrent neural networks (RNNs) (e.g., RNN, multi-layer RNN, bi-directional RNN, fused RNN, clockwork RNN, etc.). Different neural network depths may be utilized in accordance with some examples of the techniques described herein.

In some examples, the machine learning model(s) may be trained with a set of training data. The set of training data may include device management actions and triggers. For instance, a machine learning model may be trained to classify whether device management actions will cause a trigger. For instance, triggers may be utilized as classes and/or as a ground truth. The machine learning model may be trained to classify device management actions as causing a trigger or triggers and/or may be trained to infer whether device management actions may cause a trigger or triggers. In some examples, predicting 106 whether the proposed operation will trigger a device management action may be based on the machine learning model. After training, for instance, the machine learning model may classify the proposed operation as corresponding to a trigger or not and/or may infer whether the proposed operation may cause a trigger.

In some examples, the method 100 may include predicting whether the proposed operation will trigger a second device management action. For instance, trigger prediction may be performed recursively. If it is predicted that a proposed operation will trigger a device management action, the apparatus may predict whether the device management action will trigger a second device management action. Recursive prediction may be performed for a quantity of iterations and/or for an amount of time. Recursive prediction may be performed to determine whether a proposed operation will cause a cascade or loop of device management actions. For instance, a proposed operation may be installing an application on a device. Installing the application on the device may trigger the installation of Microsoft® .NET 4.5. Installing Microsoft .NET 4.5 may trigger installing Microsoft .NET 5 (and an update, for instance). However, the application may not be compatible with .NET 5, which may trigger installation of .NET 4.5 and so on. Recursive prediction may determine that installing the application may cause a loop of device management actions.

The apparatus may generate 108 a message in response to predicting that the proposed operation will trigger the device management action. Examples of a message include an image, text, an email, an alert, and/or an audio signal, etc., indicating that the proposed operation will trigger a device management action (and/or will trigger a series or loop of device management actions). The apparatus may present the message to a user. For instance, the apparatus may display the message, and/or may send the message to a user (e.g., IT administrator), etc., to notify the user that the proposed operation will trigger a device management action.

In some examples, the method 100 may include preventing the device management action. For example, the apparatus may not execute the proposed operation, may terminate the proposed operation, may modify the proposed operation to avoid causing the trigger, may disable (e.g., nullify) a trigger that would be caused by executing the proposed operation, may skip a trigger that would be caused by executing the proposed operation, and/or may skip a device management action triggered based on the proposed operation. In some examples, the apparatus may perform the proposed operation and may skip performance of any previously performed device management action triggered by the proposed operation. For instance, the apparatus may skip performing any device management action that had been monitored and/or recorded and that would be triggered by performing the proposed operation. Skipping a device management action may include skipping execution of device management action instructions. Skipping a trigger may include skipping execution of trigger instructions. Disabling (e.g., nullifying) a trigger may include blocking the execution of trigger instructions.

In some examples, the method 100 may include determining whether to perform the proposed operation after presenting the message. For instance, the apparatus may present a query to a user (e.g., IT administrator) whether to proceed with the proposed operation that would trigger a device management action. The apparatus may receive an input indicating whether to proceed. For instance, the apparatus may receive an input from a keyboard, touchscreen, mouse, microphone, controller, etc., indicating whether to proceed with the proposed operation. If the input indicates proceeding with the proposed operation, the apparatus may perform the proposed operation. If the input indicates to not proceed with the proposed operation, the apparatus may not perform the proposed operation.

In some examples, an operation or operations described in relation to FIG. 1 may be performed for multiple proposed operations. For instance, the apparatus may predict whether multiple proposed operations would trigger a device management action or actions and so on.

In some examples, the apparatus may provide a management environment. A management environment is a program or application executed on a computing device (e.g., apparatus and/or management server, etc.) to manage a device or devices. For instance, a management environment may operate on a computing device (e.g., networked device, cloud device, etc.) that is associated with (e.g., linked to) a device or devices. Some of the techniques described herein may be provided by the management environment on the apparatus. In some examples, the management environment may enable predicting whether a proposed operation will trigger a device management operation. In some examples, the management environment may be provided (e.g., hosted) by an apparatus (e.g., apparatus 302 described in relation to FIG. 3).

In some examples, the management environment may provide a structure (e.g., graph structure, map, etc.) that represents devices in the management domain. In some examples, the management environment may provide a representation of the structure in a user interface (UI). For instance, the UI may depict devices in the management domain as images (e.g., icons). In some examples, the UI may depict (and/or may be utilized to access and/or modify) a message in response to predicting that the proposed operation will trigger a device management action. In some examples, the UI may depict a control (e.g., button, checkbox, text, radio button, etc.) that enables receiving input indicating whether to proceed with a proposed operation. In some examples, operation(s), function(s), and/or element(s) of the method 100 may be omitted and/or combined.

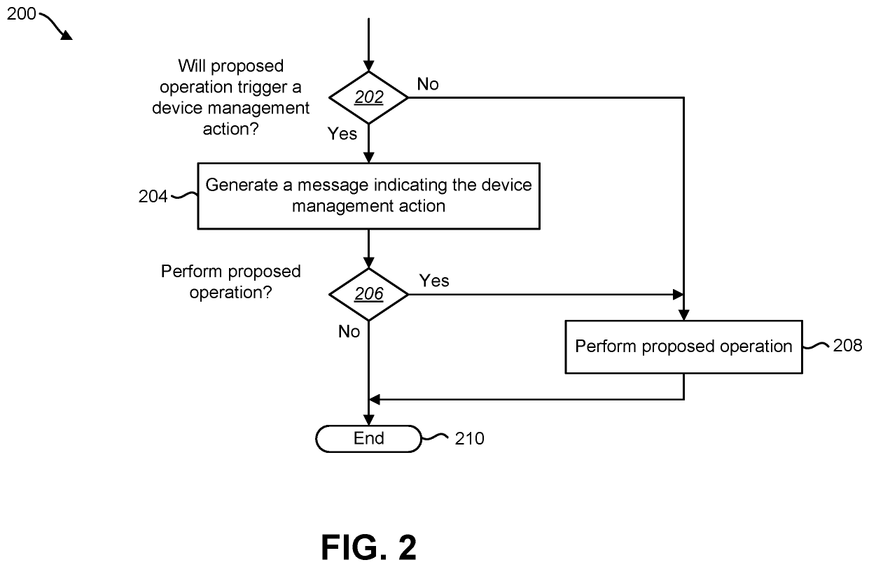

FIG. 2 is a flow diagram illustrating an example of a method 200 for management action prediction. The method 200 and/or a method 200 element or elements may be performed by an apparatus (e.g., electronic device, computing device, server, etc.). For example, the method 200 may be performed by the apparatus 302 described in relation to FIG. 3. In some examples, the method 200 or element(s) thereof described in relation to FIG. 2 may be an example of the method 100 or element(s) thereof described in relation to FIG. 1.

The apparatus may determine 202 whether a proposed operation will trigger a device management action. In some examples, determining 202 whether the proposed operation will trigger a device management action may be performed as described in relation to FIG. 1. For example, the apparatus may determine whether the proposed operation will cause a condition that satisfies a logic expression to trigger the device management action and/or may utilize a machine learning model to infer whether the proposed operation will cause a trigger.

In a case that the proposed operation will not trigger a device management action, the apparatus may perform 208 the proposed operation. For instance, the apparatus may execute the proposed operation and/or may send instructions to an agent on the device to modify the device in accordance with the proposed operation. In some examples, operation may end 210 after performing the proposed operation. In examples, operation may return to determining 202 whether performing a next proposed operation will trigger a device management action.

In a case that the proposed operation will trigger a device management action, the apparatus may generate 204 a message indicating the device management action. In some examples, generating 204 the message may be performed as described in relation to FIG. 1. For example, the apparatus may generate a message to present and/or send to a user (via a UI, email, audio signal, etc.).

The apparatus may determine 206 whether to perform the proposed operation. In some examples, determining 206 whether to perform the proposed operation may be performed as described in relation to FIG. 1. For example, the apparatus may receive an input (via an input device and/or UI, for instance) indicating whether to proceed with the proposed operation. In a case that the apparatus determines to perform the proposed operation, the apparatus may perform 208 the proposed operation.

In a case that the apparatus determines not to perform the proposed operation (e.g., the apparatus receives an input indicating to not proceed), operation may end 210 in some examples. In some examples, operation may return to determining 202 whether a next proposed operation will trigger a device management action. In some examples, operation(s), function(s), and/or element(s) of the method 200 may be omitted and/or combined.

FIG. 3 is a block diagram of an example of an apparatus 302 that may be used for management action prediction. The apparatus 302 may be a computing device, such as a server computer, a personal computer, a laptop computer, etc. The apparatus 302 may include a processor 304, a memory 306, and/or a communication interface 324. The apparatus 302 may include additional components (not shown) and/or some of the components described herein may be removed and/or modified without departing from the scope of this disclosure.

The processor 304 may be any of a central processing unit (CPU), a digital signal processor (DSP), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions stored in the memory 306. In some examples, the processor 304 may include an electronic circuit or circuits that include electronic components for performing a function or functions of the instructions. In some examples, the processor 304 may perform one, some, or all of the operations, aspects, etc., described in relation to one, some, or all of FIGS. 1-4. For example, the memory 306 may store instructions for one, some, or all of the operations, aspects, etc., described in relation to one, some, or all of FIGS. 1-4. The processor 304 may be coupled to (e.g., in electronic communication with) the memory 306.

The memory 306 may be any electronic, magnetic, optical, or other physical storage device that contains or stores electronic information (e.g., instructions and/or data). The memory 306 may be, for example, Random Access Memory (RAM), EEPROM, a storage device, an optical disc, and/or the like. In some examples, the memory 306 may be volatile and/or non-volatile memory, such as Dynamic Random Access Memory (DRAM), EEPROM, magnetoresistive random-access memory (MRAM), phase change RAM (PCRAM), memristor, flash memory, and/or the like. In some examples, the memory 306 may be a non-transitory tangible machine-readable storage medium, where the term “non-transitory” does not encompass transitory propagating signals. In some examples, the memory 306 may include multiple devices (e.g., a RAM card and a solid-state drive (SSD)). In some examples, the memory 306 of the apparatus 302 may store trigger determination instructions 310, trigger storage instructions 312, and/or proposed operation instructions 314. In some examples, the memory 306 may store device management actions, triggers, etc.

In some examples, the apparatus 302 may include a communication interface 324 through which the processor 304 may communicate with an external device or devices (e.g., the remote device 328 and/or other remote devices). In some examples, the apparatus 302 may be in communication with (e.g., have a communication link with) the remote device 328 via a network 326. Examples of the remote device 328 may include a computing device, server computer, desktop computer, laptop computer, smartphone, tablet device, game console, client device, endpoint device, end-user device, etc. Examples of the network 326 may include a local area network (LAN), wide area network (WAN), the Internet, cellular network, Long Term Evolution (LTE) network, 5G network, and/or combinations thereof, etc. In some examples, the apparatus 302 may be a cloud device. In some examples, the apparatus 302 may be a management server.

The communication interface 324 may include hardware and/or machine-readable instructions to enable the processor 304 to communicate with the remote device 328. The communication interface 324 may enable a wired and/or wireless connection to the remote device 328. In some examples, the communication interface 324 may include a network interface card and/or may also include hardware and/or machine-readable instructions to enable the processor 304 to communicate with the remote device 328. In some examples, the communication interface 324 may include hardware (e.g., circuitry, ports, connectors, antennas, etc.) and/or machine-readable instructions to enable the processor 304 to communicate various input and/or output devices, such as a keyboard, a mouse, a display, another apparatus, electronic device, computing device, etc., through which a user may input instructions and/or data into the apparatus 302. In some examples, the apparatus 302 (e.g., via processor 304) may utilize the communication interface 324 to send and/or receive information.

In some examples, the remote device 328 may include a processor, memory, and/or communication interface. In some examples, the memory of the remote device 328 may be any electronic, magnetic, optical, or other physical storage device that contains or stores electronic information (e.g., instructions and/or data), such as, for example, RAM, EEPROM, a storage device, an optical disc, and/or the like. In some examples, the processor of the remote device 328 may be any of a CPU, a DSP, a semiconductor-based microprocessor, GPU, FPGA, an ASIC, and/or other hardware device suitable for retrieval and execution of instructions stored in corresponding memory. In some examples, the communication interface of the remote device 328 may include hardware and/or machine-readable instructions to enable the remote device 328 to communicate with the apparatus 302.

In some examples, the communication interface 324 may receive a change notification from the remote device 328. For instance, the communication interface 324 may receive a change notification via the network 326 from an agent on the remote device 328. The change notification may indicate a setup change (e.g., change to a registry value, installation or removal of an application, settings change, etc.).

The processor 304 may execute the trigger determination instructions 310 to determine whether the change notification triggered a device management action. In some examples, determining whether the change notification triggered a device management action may be performed as described in relation to FIG. 1. For instance, the processor 304 may evaluate a logic expression based on the change notification to determine whether the logic expression is satisfied, thereby triggering a device management action. In some examples, the processor 304 may observe whether a device management action is executed in response to the change notification.

The processor 304 may execute the trigger storage instructions 312 to store a trigger in the memory 306 corresponding to the change notification. For instance, in a case that the processor 304 determines that the change notification triggered a device management action, the processor 304 may store the trigger corresponding to the change notification. For instance, the processor 304 may store data indicating a condition, behavior, etc., that triggered the device management action.

The processor 304 may execute the proposed operation instructions 314 to determine whether a proposed operation will trigger the device management action based on the trigger. For instance, the processor 304 may determine whether a proposed operation to modify a client device will trigger the device management action based on the trigger. In some examples, determining whether a proposed operation will trigger the device management action based on the trigger may be performed as described in relation to FIG. 1 and/or FIG. 2.

In some examples, the processor 304 may generate a message indicating the device management action. In some examples, generating a message indicating the device management action may be performed as described in relation to FIG. 1 and/or FIG. 2. For instance, the processor 304 may generate a message to present on a display of the apparatus 302 and/or to send to another device (e.g., another remote device) to notify a user that the proposed operation may trigger executing of the device management operation.

In some examples, the processor 304 may determine whether to perform the proposed operation after presenting the message. In some examples, determining whether to perform the proposed operation after presenting the message may be accomplished as described in relation to FIG. 1 and/or FIG. 2. For instance, the processor 304 may receive an input indicating whether to perform to proposed operation. In a case that the processor 304 determines to perform the proposed operation, the processor 304 may perform the proposed operation. In a case that the processor 304 determines to not perform the proposed operation, the processor 304 may not perform the proposed operation.

In some examples, the apparatus 302 may provide and/or host a management environment. In some examples, the management environment may support automated setup. In some examples of the techniques described herein, a remote device 328 may provide notifications of changes to the device (e.g., device setup). The processor 304 may test the changes in a logical expression (e.g., Boolean expression). When a condition is satisfied, a device management action may be applied to the remote device 328. In some examples of the techniques described herein, device management actions (e.g., templates, policies, etc.) may include automation instructions to place the remote device 328 into a desired setup state.

In some examples, a device management action may include multiple instructions (e.g., components), where an instruction or instructions may change the setup that is being monitored by the apparatus 302 (e.g., management server). If a notification of a change is received by the apparatus 302, a new device management action cycle may be triggered. For instance, a device management action may trigger a new device management action deployment to the remote device 328. Automated setup may be helpful in driving complex workflow actions using linked device management action triggering. Automated setup may also be monitored to help ensure that an unintended or unforeseen device management action (e.g., loop of device management actions, causal sequence of unforeseen device management actions, etc.) is not triggered. For instance, the apparatus 302 may produce a message that indicates any subsequent device management action(s) that may be triggered based on a proposed operation. This may enable preventing an unintended or unforeseen device management action.

In some examples, the apparatus 302 (e.g., management environment) may monitor and/or catalog device management actions (e.g., policies, templates, etc.) that are available for execution. Using measurements from the remote device 328 (and/or other remote devices, for instance), the apparatus 302 may catalog triggers (e.g., conditions, behaviors, etc.) that trigger execution of additional device management actions.

In some examples, the apparatus 302 (e.g., memory 306) may maintain dataset and/or database of logical expressions (e.g., logical expressions used to trigger execution of device management actions). The dataset and/or database may be used in conjunction with device management actions (e.g., newly created proposed operations and the rules of logical expressions of previous device management actions) to identify cases where deploying a proposed operation to the remote device 328 will trigger a device management action that is being monitored by the apparatus 302. In some examples, the case identification may be performed recursively, which may identify cascading changes in setup and/or multiple device management actions deployed in succession.

Some examples of the techniques described herein may be used to identify outcomes of deploying a proposed operation or operations (e.g., new policy) to devices. For instance, the apparatus 302 may detect side effects and/or automatic triggering of device management actions instantiated as a result of the proposed operation. Information about detected side effects and/or triggering may be provided to a user (e.g., IT administrator) to help make informed decision regarding the use of a proposed operation. Some examples of the techniques described herein may provide an automation toolset while providing procedures to inform a user of potential consequences of proposed operations.

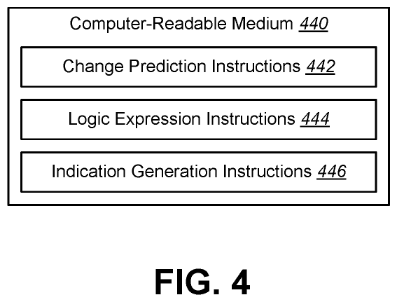

FIG. 4 is a block diagram illustrating an example of a computer-readable medium 440 for management action prediction. The computer-readable medium is a non-transitory, tangible computer-readable medium 440. The computer-readable medium 440 may be, for example, RAM, EEPROM, a storage device, an optical disc, and/or the like. In some examples, the computer-readable medium 440 may be volatile and/or non-volatile memory, such as DRAM, EEPROM, MRAM, PCRAM, memristor, flash memory, and/or the like. In some examples, the memory 306 described in relation to FIG. 3 may be an example of the computer-readable medium 440 described in relation to FIG. 4.

The computer-readable medium 440 may include data (e.g., instructions, executable code, and/or information). For example, the computer-readable medium 440 may include change prediction instructions 442, logic expression instructions 444, and/or indication generation instructions 446.

The change prediction instructions 442 may be executed by a processor to predict a change on a remote device (e.g., client device) based on a proposed operation to modify the remote device (e.g., client device). In some examples, predicting the change may be accomplished as described in relation to FIG. 1, FIG. 2, and/or FIG. 3.

The logic expression instructions 444 may be executed by the processor to determine whether the change satisfies a logic expression. This may be accomplished as described in relation to FIG. 1, FIG. 2, and/or FIG. 3 in some examples.

The indication generation instructions 446 may be executed by the processor to generate an indication of a device management action in response to determining that the change satisfied the logic expression. This may be accomplished as described in relation to FIG. 1, FIG. 2, and/or FIG. 3 in some examples.

In some examples, the computer-readable medium 440 may include instructions when executed cause the processor to determine whether to perform the proposed operation. This may be accomplished as described in relation to FIG. 1, FIG. 2, and/or FIG. 3 in some examples. In some examples, the computer-readable medium 440 (e.g., the instructions to determine whether to perform the proposed operation) may include instructions when executed cause the processor to receive an input indicating whether to perform the proposed operation. This may be accomplished as described in relation to FIG. 1, FIG. 2, and/or FIG. 3 in some examples.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples of systems and methods are described herein, the systems and methods are not limited to the examples. Variations of the examples described herein may be implemented within the scope of the disclosure. For example, operations, aspects, and/or elements of the examples described herein may be omitted or combined.

What is claimed is:

1. A method, comprising:
monitoring device management actions;
predicting whether a proposed operation to modify a client device will trigger a device management action based on triggers and the device management actions; and
generating a message in response to predicting that the proposed operation will trigger the device management action.

2. The method of claim 1, further comprising:
receiving a change notification from a remote device; and
determining that the change notification triggered a first device management action.

3. The method of claim 2, further comprising storing the triggers associated with the device management actions, wherein storing the triggers comprises storing a first trigger corresponding to the first device management action in response to determining that the change notification triggered the first device management action.

4. The method of claim 1, wherein the triggers comprise a condition that satisfies a logic expression.

5. The method of claim 4, wherein predicting that the proposed operation will trigger a device management action comprises determining that the proposed operation will cause the logic expression to be satisfied.

6. The method of claim 1, further comprising training a machine learning model based on the device management actions and the stored triggers.

7. The method of claim 6, wherein predicting whether the proposed operation will trigger a device management action is based on the machine learning model.

8. The method of claim 1, further comprising predicting that the device management action will trigger a second device management action.

9. The method of claim 1, further comprising preventing the device management action, wherein preventing the device management action comprises terminating the proposed operation, modifying the proposed operation, disabling a trigger, skipping a trigger, or skipping the device management action.

10. An apparatus, comprising:
a communication interface to receive a change notification from a remote device;
a memory; and
a processor coupled to the memory, wherein the processor is to:
determine that the change notification triggered a device management action;
store, in the memory, a trigger corresponding to the change notification; and
determine whether a proposed operation to modify a client device will trigger the device management action based on the trigger.

11. The apparatus of claim 10, wherein the processor is to generate a message indicating the device management action.

12. The apparatus of claim 11, wherein the processor is to determine whether to perform the proposed operation after presenting the message.

13. A non-transitory tangible computer-readable medium comprising instructions when executed cause a processor to:
predict a change on a client device based on a proposed operation to modify the client device;
determine whether the change satisfies a logic expression; and
generate an indication of a device management action in response to determining that the change satisfies the logic expression.

14. The non-transitory tangible computer-readable medium of claim 13, further comprising instructions when executed cause the processor to determine whether to perform the proposed operation.

15. The non-transitory tangible computer-readable medium of claim 14, further comprising instructions when executed cause the processor to receive an input indicating whether to perform the proposed operation.
